(19) United States
(12) Patent Application Publication
(10) Pub. No.: US 2008/0104221 A1
(43) Pub. Date: May 1, 2008

(54) METHOD AND SYSTEM FOR SIMPLE NETWORK MANAGEMENT PROTOCOL BASED DATA MANAGEMENT

(75) Inventor: Lan Zou, Shenzhen (CN)

Correspondence Address: SUGHRUE MION, PLLC, 2100 PENNSYLVANIA AVENUE, N.W., SUITE 800, WASHINGTON, DC, 20037, US

(73) Assignee: HUAWEI TECHNOLOGIES CO., LTD., Shenzhen (CN)

(21) Appl. No.: 11/969,403

(22) Filed: Jan. 4, 2008

Related U.S. Application Data
(63) Continuation of application No. PCT/CN2006/001727, filed on Jul. 17, 2007.

(30) Foreign Application Priority Data
Jul. 15, 2005 (CN) 200510084267.4
Aug. 3, 2005 (CN) 200510089024.X

(51) Int. Cl. G06F 15/173; G06F 17/30; G06F 7/00

(52) U.S. Cl. 709/223; 707/10

(57) ABSTRACT

A method and a system for Simple Network Management Protocol (SNMP)-based data management are disclosed. The method includes: receiving, by a network element, a data management control message from a network manager through a data management node set in an SNMP Management Information Base (MIB); and implementing, by the network element, an operation according to the data management control message. By the scheme, the network manager can implement operations such as software managing, issuing a batch of configuration data, activating new configurations, backup of important data, etc. on the network element.

### FIELD OF THE INVENTION

The present invention relates to data management technologies, and more particularly to a method and a system for Simple Network Management Protocol (SNMP)-based data management.

### BACKGROUND OF THE INVENTION

The World Interoperability for Microwave Access (WiMAX) technology is a wireless Metropolitan Area Network (MAN) technology based on the Institution of Electrical and Electronics Engineers (IEEE) 802.16 series standard. The maximum transmission speed of the WiMAX may reach 75 Mbit/s. A radius of signal transmission achieves 50 kilometers, which is almost enough to cover the outskirts of a city. As having the remote distance transmission characteristics, the WiMAX is not only a technology for solving a wireless access, but also functions as a wireless extension of wired network access such as Cable, Digital Subscriber Line (DSL) and the like, thereby realizing network connections at a remote area conveniently. As a result, the WiMAX has a broad application future.

FIG. 1 shows a schematic diagram of the structure of a WiMAX network. The WiMAX includes a central network, a network manager, a Base Station (BS), a Subscriber Station (SS) and a subscriber Terminal Equipment (TE). The central network provides a function of accessing the Internet. The network manager is used to monitor and control all BSs and SSs in the network, and provide functions such as management, control and the like. The BS provides connection between the SS and the central network. The SS provides relay connection between the BS and the TE. The TE can be independent of the SS or integrated with the SS. The TE itself does not belong to the WiMAX system.

In the application of the WiMAX, the centralized management of two new introduced network elements BS and SS at the access side by the network manager is involved. In existing technical solutions, the network manager implements centralized management of the BS and the SS by using the Simple Network management Protocol (SNMP) respectively, and defines corresponding SNMP Management Information Base (MIB) nodes for the BS and the SS. The network manager completes parameter configurations for the BS and the SS through SNMP operations. In other words, the network manager sends control messages and configures parameters through corresponding nodes, and the BS or the SS performs parameter configuration according to the control messages and the parameters. However, in the node definitions of the MIB, there is no definition of nodes for BS and SS software and data management function. Operations such as issuing a batch of configuration data, an activation of new configurations, backup of important data, and the like can only be completed through using local maintenance terminals, by manual work, at the present field. Since the distribution area of the BSs and the SSs is broad, the update and data maintenance operations will consume a great amount of time and money, which greatly increases the equipment maintenance cost.

### SUMMARY OF THE INVENTION

The present invention provides a method and system for Simple Network Management Protocol (SNMP)-based data management, to enable a network manager to implement data management for a number of network elements distributed in the network.

The present invention provides a method for SNMP-based data management, includes: receiving, by a network element, a data management control message from a network manager through a data management node set in an SNMP Management Information Base (MIB); and implementing, by the network element, an operation according to the data management control message.

The present invention also provides a system for SNMP-based data management, includes: a network manager and a network element; and

the network element is adopted to receive a data management control message from the network manager through a data management node set in an SNMP MIB, and implement an operation according to the data management control message.

It can be seen from the method and system in the solution that, according to the present invention, a data management node for managing data is added into the SNMP MIB shared by the network manager and the network element. Therefore, the network manager can send various data management control messages to the network element through the data management node; and the operation unit of the network element implements data management operations according to the control messages. Through the SNMP manner, the network manager can manage the data on the network element remotely in the present invention. Thus operations such as software management, issuing a batch of configuration data, an activation of new configurations, backup of important data, and the like can be implemented, by the network manager, on the network element. Further, the network manager can receive the operation progress and operation result from the network element, thereby facilitating the service providers in monitoring the operations in real time. The present invention fills the gap that there is no data management for the BS and the SS based on the SNMP. Moreover, the present invention saves the time and fund cost in the data management and maintenance operation, the devoted manpower, and reduces the maintenance cost of devices to a great extent.

### BRIEF DESCRIPTION OF THE DRAWINGS

FIG. 1 is a schematic diagram illustrating the structure of a WiMAX system.

FIG. 2 is a diagram shows relationships among a network manager, network elements and a storage unit.

FIG. 3 is a flow chart in accordance with a first preferred embodiment of the present invention.

FIG. 4 is a schematic diagram showing the structure of a system in accordance with the first and a third preferred embodiments of the present invention.

FIG. 5 is a flow chart in accordance with a second preferred embodiment of the present invention.

FIG. 6 is a schematic diagram showing the structure of a system in accordance with the second and a fourth preferred embodiments of the present invention.

FIG. 7 is a flow chart in accordance with the third preferred embodiment of the present invention.

FIG. 8 is a flow chart in accordance with the fourth preferred embodiment of the present invention.

FIG. 9 is a flow chart in accordance with a fifth preferred embodiment of the present invention.

FIG. 10 is a schematic diagram showing the structure of a system in accordance with the fifth preferred embodiment of the present invention.

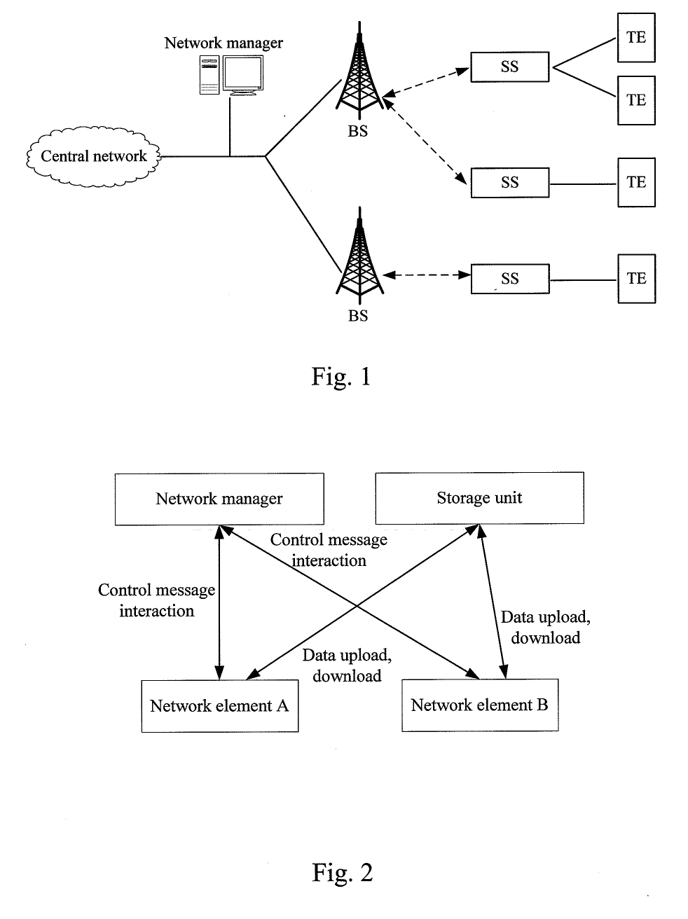

### EMBODIMENTS OF THE INVENTION

In order to make the technical schemes and merits of the present invention clearer, a detailed description of the present invention is hereinafter given with reference to the embodiment.

In the present invention, a data management node is set in an SNMP MIB; control messages are transmitted through the data management node; data management operations are performed according to the control messages.

The network manager in the present invention is a Network Management System (NMS), a network Element Management System (EMS) or a local maintenance terminal. The NMS, EMS or local maintenance terminal uses the SNMP. The network element in the present invention includes but is not limited to the BS and the SS. The data in the present invention includes all data could be interchanged between the network manger and the network element. For example, the data may be software, network element's configuration file, network elements's backup data. The present invention is applicable to any system using the SNMP, and is not limited to the WiMAX system. The present invention further relates to a storage unit for storing data, and the storage unit may be separate from or located in the network manager. FIG. 2 shows relationships among the network manger, independent storage unit, network element A and network element B. There are interactions of control messages between the network manager and network element A, and between the network manager and network element B. There are data transmissions between the storage unit and network element A, and between the storage unit and network element B. In other words, data is downloaded from the storage unit to a network element and data is uploaded from the network element to the storage unit.

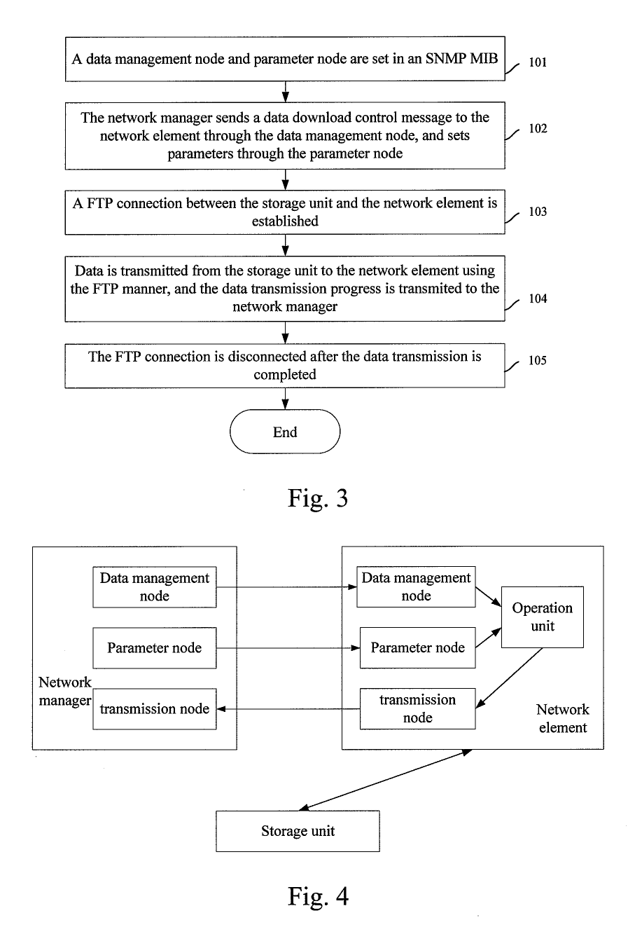

A first preferred embodiment illustrates the process of transmitting data from a storage unit to a network element. The data may be transmitted between the storage unit and the network element in multiple manners, for example, Trivial File Transfer Protocol (TFTP), File Transfer Protocol (FTP). In the first preferred embodiment, the FTP manner is used in the data transmission as an example. With reference to FIG. 3, the method according to the first preferred embodiment is as follows.

In block 101, a data management node for transmitting a control message, a parameter node and a transmission node are preset in an SNMP MIB. The parameter node is used for transmitting parameters. The transmission node is used for a network element transmitting a message to the network manager. The parameters include location information of the storage unit, a path and a file name of the data to be transmitted in the storage unit. For example, the location information is the IP address of the storage unit. If the FTP manner which needs a user name and a password is adopted, the parameters should include the user name and the password.

In block 102, the network manager transmits a data download control message through the data management node, and sets the parameters through the parameter node.

In block 103, an FTP connection between the storage unit and the network element is established according to the IP address of the storage unit. If the FTP manner which needs a user name and a password is adopted, the FTP connection is established further according to the user name and the password.

In block 104, data corresponding to the path and the file name in the storage unit is transmitted to the network element in FTP manner.

Before the block 104, determination of whether the FTP connection is successful may be further implemented. If the FTP connection is successful, the procedure proceeds to block 104. Otherwise, a connection failure message is transmitted to the network manager through the transmission node.

Further, the network elements in this embodiment may transmit data download progress to the network manager through the transmission node so that the service providers can monitor the data download status at the network manager in real time.

In block 105, the FTP connection is disconnected after data transmission is finished. The network element may further transmit data download result to the network manager through the transmission node, for example, the result refers to a message indicating that the data download succeeds or fails.

Data is transmitted to the BS and the SS according to the method in the first preferred embodiment.

The method according to the first preferred embodiment may be implemented through the system shown in FIG. 4. The system includes a network manager, a network element and a storage unit for storing data. The storage unit may be separate from or located in the network manager. The storage unit shown in FIG. 4 is separate from the network manager. The SNMP MIB includes a data management node for transmitting the data download control message, a parameter node for transmitting parameters. The SNMP MIB may further include a transmission node by which the network element can transmit the data download progress and result to the network manager.

In the implementation of the first preferred embodiment, the network manager transmits the data download control message through the data management node and sets parameters through the parameter node. An operation unit establishes the FTP connection between the storage unit and the network element according to the data download control message and the IP address of the storage unit in the parameters. If the FTP manner which needs a user name and a password is adopted, the FTP connection is established further according to the user name and the password. The operation unit may further determine whether the connection is successful. If successful, the FTP manner is used to transmit the data corresponding to the path and the file in the storage unit to the network element. Otherwise, a connection failure message is transmitted to the network manager through the transmission node. During the transmission process, the operation unit may transmit the data download progress to the network manager through the transmission node. After data transmission is finished, the operation unit disconnects the FTP connection, and may further transmit the result of download to the network manager through the transmission node.

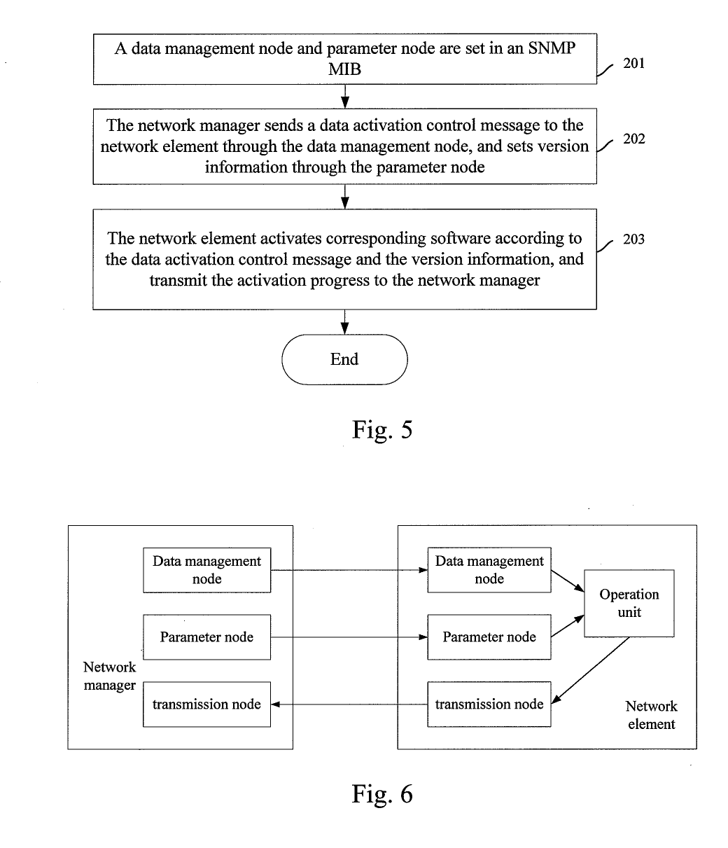

A second preferred embodiment of the present invention illustrates the process of activating data on a network element. The data to be activated is already existing on the network element. For example, the data has been downloaded to the network element by the method according to the first preferred embodiment. With reference to FIG. 5, the method according to the second preferred embodiment is as follows.

In block 201, a data management node for transmitting a control message is preset in an SNMP MIB; a parameter node and a transmission node may be further set in the SNMP MIB. The parameter node is used for transmitting parameters. The transmission node is used for the network element transmitting messages to the network manager. The parameters include version information of the data to be activated.

The data management node mentioned in different embodiment of this description corresponds to different nodes with different functions.

In block 202, the network manager transmits a data activation control message to the network element through the data management node; and sets the version information of the data to be activated through a parameter node.

In block 203, the network element activates data on the network element according to the data control information and the version information. The data is identified by the version information. The data may be network element's software, configuration file. If there is a primary version identifier for identifying the current data's primary version, the network element may update the primary version identifier to the version information of the data activated in this block.

The parameter node need not be set in block 201 and the parameters need not be set in block 202 if the data to be activated is preset default data. For example, the preset default data is the data latest downloaded.

Further, the network element in this embodiment may transmit the data activation progress and result through the transmission node so that the service providers can monitor the data activation status at the network manager in real time. The result refers to a message indicating that the data activation succeeds or fails.

If data is downloaded from the storage unit by the method in the first preferred embodiment, and the downloaded data is activated by the method in the second preferred embodiment, data updating in the network element is completed.

The second preferred embodiment may be implemented through the system shown in FIG. 6. The system includes a network manager and a network element. An SNMP MIB includes a data management node for transmitting a data activating control message, a parameter node for transmitting the parameters in the second preferred embodiment, and a transmission node for the network element transmitting messages to the network manager.

In the implementation of the second preferred embodiment, the network manager transmits the data activation control message to the network element through the data management node, and sets the version information of the data to be activated through the parameter node. The operation unit activates the data on the network element according to the data control information and the version information. The data is identified by the version information. If there is a primary version identifier for identifying the current data's primary version on the network, the operation unit may update the primary version identifier to the version information of the activated data. Further, the operation unit may transmit data activation progress and result to the network manager through the transmission node so that the service providers can monitor the data activation status at the network manager in real time.

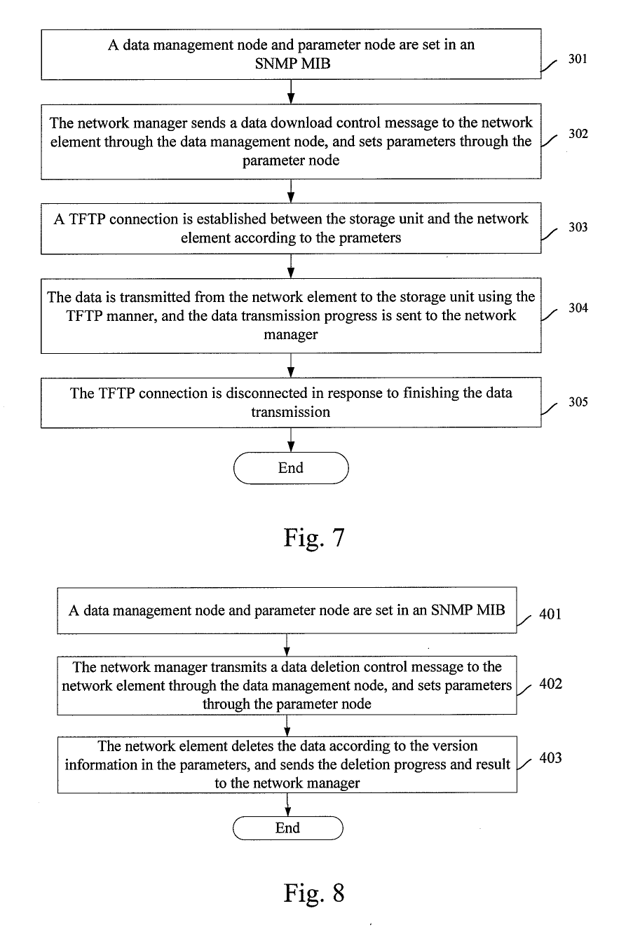

A third preferred embodiment illustrates the process of uploading data from the network element to the storage unit. There are multiple manners, such as TFTP, FTP, for data transmission between the storage unit and the network element. Different from the first preferred embodiment, the TFTP manner is used as an example in the third preferred embodiment to illustrate the process of data transmission. With reference to FIG. 7, the method according to the third preferred embodiment is as follows.

In block 301, a data management node for transmitting a control message is preset in an SNMP MIB; a parameter node and a transmission node may be preset in the SNMP MIB. The parameter node is used for transmitting parameters. The transmission node is used for the network element transmitting messages to the network manager. The parameters include location information of the storage unit, and version information of the data to be uploaded. The location information of the storage unit is the IP address of the storage unit. As the TFTP does not need a user name and a password, the parameters in this block do not include the user name and the password.

In block 302, the network manager transmits a data upload control message to the network element through the data management node, and sets the parameters through the parameter node.

In block 303, a TFTP connection is established between the storage unit and the network element according to the IP address of the storage unit and the data upload control message.

In block 304, the data corresponding to the version information is transmitted from the network element to the storage unit in TFTP manner.

Before the block 304, determination of whether the connection is successful may be further implemented. If successful, the procedure proceeds to block 304. Otherwise, a connection failure message is transmitted to the network manager.

Further, the network elements in this embodiment may transmit the data upload progress to the network manager through the transmission node so that the service providers can monitor data upload progress at the network manager in real time.

In block 305, the TFTP connection is disconnected after the data transmission is finished. The network element may further transmit an upload result to the network manager through the transmission node. For example, the result refers to a message indicating the data identified by the version information is uploaded successfully.

The third preferred embodiment can be implemented through the system with reference to FIG. 4. The system includes a network manager, a network element, and a storage unit for storing data, the storage unit may be separate from or located in the network manager. An SNMP MIB includes a data management node for transmitting a data upload control message, a parameter node for transmitting the parameters in the third preferred embodiment, and a transmission node for the network element transmitting messages to the network manager.

In the implementation of the third preferred embodiment, the network manager transmits the data upload control message to the network element through the data management node, and sets the parameters through the parameter node. The operation unit establishes a TFTP connection between the storage unit and the network element according to the data upload control message and the IP address of the storage unit. The operation unit may further determine whether the connection is successful. If the connection is successful, the TFTP manner is adopted to transmit the data corresponding to the version information from the network element to the storage unit. Otherwise, a connection failure message is transmitted to the network manager through the transmission node. Further, the operation unit may transmit the data upload progress to the network manger through the transmission node so that the service providers can monitor the data upload status at the network manager in real time. After the data transmission is finished, the operation unit disconnects the TFTP connection. The operation unit may further transmit the upload result to the network manager through the transmission node.

It can be seen from the first and third preferred embodiments that the download and upload of the data can be concluded as the following data transmission process.

Process 1: A data management node for transmitting a control message is preset in an SNMP MIB; a parameter node and a transmission node may be further preset in the SNMP MIB. The parameter node is used for transmitting parameters. The transmission node is used for network elements transmitting messages to the network manager.

During data download, the parameters include the location information of the storage unit and the identifier information of the data to be downloaded. The location information of the storage unit is the IP address of the storage unit. The identifier information of the data to be downloaded is the path and the file name of the data to be transmitted in the storage unit. During data upload, the parameters include the location information of the storage unit and the identifier information of the data to be uploaded. The location information of the storage unit is the IP address of the storage unit. The identifier information of the data to be uploaded includes the version information of the data to be uploaded. The location information of the storage unit may be other information besides the IP address, for example, when the storage unit is located in the network manager, the location information of the storage unit may be the path information, or the port information of the storage unit. Because there is a connection between the network manager and the network element, no connection is needed between the storage unit and the network element in the following processes. If the FTP manner which needs a user name and a password is adopted, the parameters need to include the user name and the password.

Process 2: The network manager transmits a data transmission control message to the network element through the data management node, and sets the parameters through the parameter node.

During data download, the data transmission control message is the data download control message. During data upload, the data transmission control message is the data upload control message.

Process 3: A connection between the storage unit and the network element is established according to the IP address of the storage unit.

If the FTP manner is adopted, the connection is established further according to the user name and the password.

Process 4: The data corresponding to the identifier information is transmitted between the network element and the storage unit.

Before process 4, determination of whether the connection is successful may be further implemented. If the connection is successful, the procedure proceeds to process 4. Otherwise, a connection failure message is transmitted to the network manger through the transmission node.

Further, the network elements may transmit data transmission progress to the network manger through the transmission node so that the service providers can monitor data transmission status at the network manager in real time.

Process 5: After the data transmission is finished, the connection between the network element and the storage unit is disconnected. The network element may transmit a transmission result to the network manager through the transmission node. For example, the result is a message indicating that the transmission of the version information succeeds or fails.

If a connection is already existing between the storage unit and the network element, for example the storage unit is located in the network manager. The connection between the storage unit and the network element need not be established during the data transmission process. In this case, the data transmission processes are as follows.

Process 1: A data management node for transmitting a control message is preset in an SNMP MIB; a parameter node and a transmission node may be further preset in the SNMP MIB. The parameter node is used for transmitting parameters. The transmission node is used for network element transmitting messages to the network manager.

During data download, the parameters include the location information of the storage unit and the identifier information of the data to be transmitted. During data upload, the parameters include the location information of the storage unit and the identifier information of the data to be transmitted.

Process 2: The network manager transmits a data transmission control message to the network element through the data management node, and sets the parameters through the parameter node.

For data download, the data transmission control message is the data download control message. For data upload, the data transmission control message is the data upload control message.

Process 3: The data corresponding to the identifier information is transmitted between the network element and the storage unit.

Further, the network element may transmit data transmission progress to the network manger through the transmission node so that the service providers can monitor the data transmission status at the network manager in real time.

Process 4: The network element may further transmit a result of transmission to the network manager through the transmission node. For example, the result refers to a message indicating that the transmission of the data corresponding to the identifier information succeeds or fails.

A fourth preferred embodiment illustrates the process of deleting data on a network element. With reference to FIG. 8, the method according to the fourth preferred embodiment is as follows.

In block 401, a data management node for transmitting a control message is preset in an SNMP MIB; a parameter node and a transmission node may be further preset in the SNMP MIB. The parameter node is used for transmitting parameters. The transmission node is used for network element transmitting messages to the network manager. The parameters include version information of the data to be deleted.

In block 402, the network manager transmits a data deletion control message to the network element through the data management node, and sets the version information of the data to be deleted through the parameter node.

In block 403, the network element deletes the data on the network element according to the data deletion control message and the version information. The data deleted is identified by the version information.

Further, the network element in this embodiment may transmit the data deletion progress and result through the transmission node so that the service providers can monitor the data deletion status at the network manager in real time. The result refers to a message indicating that the data deletion succeeds or fails.

The fourth preferred embodiment may be implemented through the system shown in FIG. 6. The system includes a network manager and a network element. The SNMP MIB in each of the network manager and the network element includes a data management node for transmitting a data deletion control message, a parameter node for transmitting the parameters in the fourth preferred embodiment, and a transmission node for the network element transmitting messages to the network manager.

In the implementation of the fourth preferred embodiment, the network manager transmits the data deletion control message to the network element through the data management node, and sets the version information of the data to be deleted through the parameter node. The operation unit deletes the data on the network element according to the data deletion control message and the version information. Further, the operation unit may transmit the data deletion progress and result to the network manger through the transmission node so that the service providers can monitor the data deletion status at the network manager in real time.

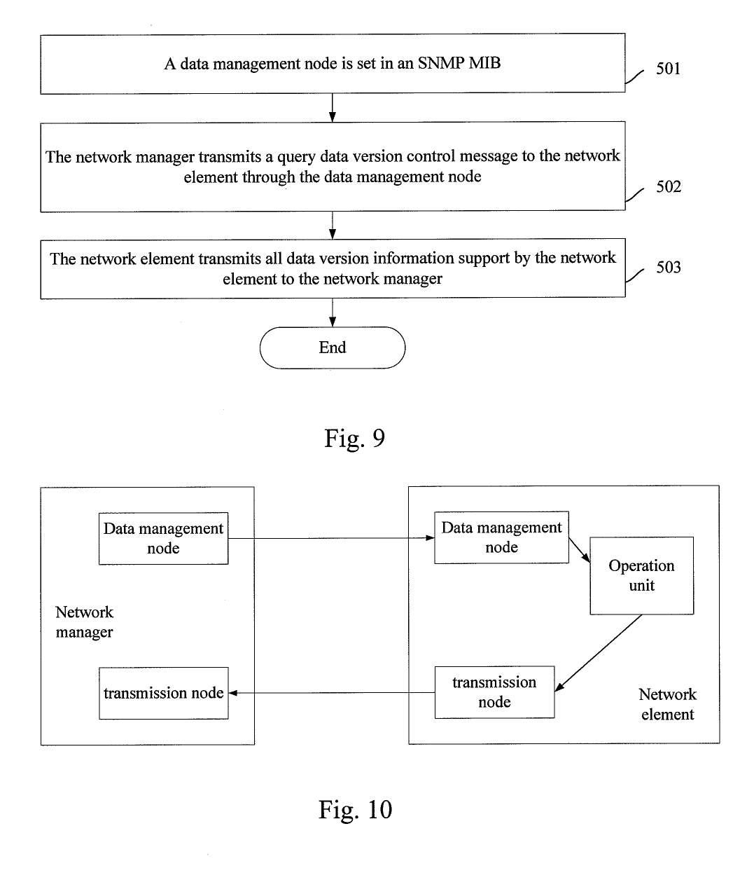

A fifth preferred embodiment of the present invention illustrates the process of data version querying on a network element. With reference to FIG. 9, the method according to the fifth preferred embodiment is as follows.

In block 501, a data management node and a transmission node are preset in an SNMP MIB. The data management node is used for transmitting control messages. The transmission node is used for the network element transmitting messages to the network manager.

In block 502, the network manager transmits a query data version control message to the network element through the data management node.

In block 503, the network element transmits, according to the query data version control information, all data version information supported by the network element to the network manager through the transmission node.

The fifth preferred embodiment may be implemented through a system shown in FIG. 10. The system includes a network manager and a network element. The SNMP MIB in each of the network manager and the network element includes a data management node for transmitting a query network element data version control message and a transmission node for the network element transmitting messages to the network manager.

In the implementation of the fifth preferred embodiment, the network manager transmits a query data version control message to the network element through the data management node. The network element transmits all data version information supported by the network element to the network manager through the transmission node according to the query data version control information.

The above is the description of the detailed embodiments of the present invention. The method of the present invention can be modified appropriately during a specific implementation, to meet the specific requirements of the specific cases. It is thereby understood that the detailed embodiments according to the present invention are just demonstrative of, but not limitative to the protection scope of the present invention.

What is claimed is:

1. A method for Simple Network Management Protocol (SNMP)-based data management, comprising:
receiving, by a network element, a data management control message from a network manager through a data management node set in an SNMP Management Information Base (MIB); and
implementing, by the network element, an operation according to the data management control message.

2. The method of claim 1, wherein the data management control message is a data transmission control message;
the method further comprises:
receiving, by the network element, location information of a storage unit and identifier information of data to be transmitted from the network manager through a parameter node set in the SNMP MIB;
wherein the location information of the storage unit and the identifier information of data to be transmitted are configured by the network manager via the parameter node set in the SNMP MIB; and
the implementing by the network element the operation according to the data management control message comprises:
transmitting data between the storage unit and the network element according to the data transmission control message, the location information of the storage unit and the identifier information of data to be transmitted.

3. The method of claim 2, wherein the data transmission control message is a data download control message;
the identifier information of data to be transmitted comprises a path and a file name of data to be downloaded in the storage unit; and
the transmitting data between the storage unit and the network element comprises:
downloading, by the network element, data corresponding to the path and the file name from the storage unit.

4. The method of claim 2, wherein the data transmission control message is a data upload control message;
the identifier information of data to be transmitted comprises version information of data to be uploaded; and
the transmitting data between the storage unit and the network element comprises:
uploading, by the network element, data corresponding to the version information to the storage unit.

5. The method of claim 2, wherein the location information of the storage unit is selected from the group consisting of an IP address of the storage unit, path information of the storage unit, and port information of the storage unit.

6. The method of claim 2, wherein the transmitting data between the storage unit and the network element comprises:
establishing, by the network element, a connection with the storage unit according to the data transmission control message and the location information of the storage unit; and
transmitting the data between the storage unit and the network element through the connection.

7. The method of claim 6, wherein the connection is selected from the group consisting of a File Transfer Protocol (FTP) connection and a Trifle File Transfer Protocol (TFTP) connection.

8. The method of claim 6, further comprising:
determining, by the network element, whether the connection is successfully established, if the connection is successfully established, transmitting the data between the storage unit and the network element through the connection; otherwise, transmitting a connection failure message to the network manager through the data management nodes.

9. The method of claim 1, wherein the data management control message is a data activation control message; and
the implementing by the network element the operation according to the data management control message comprises:
activating, by the network manager, preset data according to the data activation control message.

10. The method of claim 9, wherein the preset data is preset default data.

11. The method of claim 9, further comprising:
receiving, by the network element, version information of the data to be activated from the network manager through a parameter node set in the SNMP MIB;
wherein the version information of the data to be activated is configured by the network manager via the parameter node set in the SNMP MIB;
the preset data is corresponding to the version information.

12. The method of claim 9, wherein the network element comprises a primary version identifier for identifying the current data's primary version; and
activating, by the network manager, preset data according to the data activation control message comprises:
updating, by the network element, the primary version identifier to the version information of the data to be activated.

13. The method of claim 1, wherein the data management control message is a data deletion control message;
the method further comprises:
receiving, by the network element, version information of the data to be deleted from the network manager through a parameter node set in the SNMP MIB;
wherein the version information of the data to be deleted is configured by the network manager via the parameter node set in the SNMP MIB;
the implementing by the network element the operation according to the data management control message comprises:
deleting, by the network element, data corresponding to the version information of the data to be deleted according to the data deletion control message and the version information of the data to be deleted.

14. The method of claim 1, wherein the data management control message is a query network element data version control message;
the method further comprises:
transmitting, by the network element, all data version information supported by the network element to the network manager through a transmission node set in the SNMP MIB, according to the query network element data version control information.

15. The method of claim 1, wherein a transmission node is set in the SNMP MIB;
the method further comprises:
transmitting, by the network element, at least one of an operation progress and an operation result to the network manager through the transmission node.

16. A system for Simple Network Management Protocol (SNMP)-based data management, comprising a network manager and a network element; wherein
the network element is adapted to receive a data management control message from the network manager through a data management node set in an SNMP Management Information Base (MIB), and implement an operation according to the data management control message.

17. The system of claim 16, wherein the SNMP MIB further comprises:
a parameter node, for configuring parameters related to the data management control message and transmitting the parameters to the network element; and
the network element comprises:
an operation unit, for implementing the operation according to the data management message and the parameters.

18. The system of claim 17, further comprising:
a storage unit, for storing data;
wherein the operation is data transmission between the operation unit and the storage unit.

19. The system of claim 18, wherein the storage unit is separate from the network manager.

20. The system of claim 18, wherein the storage unit is located in the network manager.

21. The system of claim 16, wherein the SNMP MIB further comprises:
a transmitting node, for transmitting data version information supported by the network element to the network manager.

22. The system of claim 16, wherein the SNMP MIB further comprises:
a transmitting node, for transmitting at least one of an operation progress and an operation result from the network element to the network manager.

23. The system of claim 16, wherein the network manager is selected from the group consisting of a Network Management System (NMS), a network Element Management System (EMS) and a local maintenance terminal.

24. The system of claim 16, wherein the network element is selected from the group consisting of a Base Station (BS) and a Subscriber Station (SS).
